(19) United States
(12) Patent Application Publication
(10) Pub. No.: US 2011/0304202 A1
(43) Pub. Date: Dec. 15, 2011

(54) BATTERY DISCONNECTION IN ELECTRIC VEHICLES

(75) Inventors: Broc William TenHouten, Santa Monica, CA (US); David Leslie Edwards, Newburgh, IN (US); Zhanping (Joseph Z.) Wu, Los Angeles, CA (US); Philippe Hart Gow, Santa Monica, CA (US); James Howard Frasher, III, Glendora, CA (US); Phillip John Weicker, Pasadena, CA (US); Peter Fredrick Nortman, Monrovia, CA (US)

(73) Assignee: Coda Automotive, Inc., Santa Monica, CA (US)

(21) Appl. No.: 13/104,386

(22) Filed: May 10, 2011

Related U.S. Application Data
(60) Provisional application No. 61/334,406, filed on May 13, 2010.

(51) Int. Cl. B60L 1/00

(52) U.S. Cl. 307/10.1

(57) ABSTRACT

Systems and methods for disconnection of battery power from vehicular components in an electric vehicle upon the occurrence of a crash event are described. In an embodiment of an electric vehicle, upon detection of a crash event, an appropriate signal is transmitted through a controller area network (CAN). A battery management unit (BMU) detects the signal and then severs a power connection between the battery and one or more vehicular components of the electric vehicle. In another embodiment of an electric vehicle, a crash event is detected and a signal to deploy an airbag and/or a pretensioner is emitted. Once a decision is made to deploy the airbag and/or the to pretensioner, the BMU then cuts off battery power to one or more vehicular components of the electric vehicle.

### RELATED APPLICATIONS

This application claims priority under 35 U.S.C. §119(e) to U.S. Provisional Patent Application No. 61/334,406, filed May 13, 2010, and entitled “Battery Disconnection in Electric Vehicles,” which is incorporated herein by reference in its entirety for all purposes.

### BACKGROUND

1. Field

Aspects herein relate to systems and methods for battery disconnection in electric vehicles.

2. Discussion of Related Art

Electric vehicles include a number of components (e.g., electric motors) that are powered by one or more batteries disposed within each vehicle. In the event of an automobile accident, various safety mechanisms are commonly employed to ensure the protection of passengers within the vehicle. Examples of such safety mechanisms include activation of a seatbelt pretensioner and/or deployment of an airbag. However, upon experiencing a crash, it may be desirable for power to be disconnected from various components.

### SUMMARY

Aspects presented herein relate to automatic disconnection of a battery from one or more components in an electric vehicle in the event of a crash.

In one illustrative embodiment, a system in an automobile adapted to disconnect electrical power in the automobile upon detection of a crash event is provided. The system includes at least one vehicular component; a battery for supplying electrical power to the at least one vehicular component; a contactor for providing electrical communication between the at least one vehicular component and the battery when the contactor is in a closed configuration; a battery management unit in communication with the contactor and being adapted to provide a disconnect signal that results in the contactor achieving an open configuration that severs a power connection between the at least one vehicular component and the battery; a crash detection unit adapted to emit a crash signal upon making a determination as to whether the crash event has occurred; and a controller area network in communication with a plurality of control units including the battery management unit and the crash detection unit, wherein upon occurrence of the crash event, the controller area network is adapted to receive the crash signal from the crash detection unit and the battery management unit is adapted to sense a signal that indicates that the crash event has occurred from the controller area network for emitting the disconnect signal.

In another illustrative embodiment, a system in an automobile adapted to to disconnect electrical power in the automobile upon detection of a crash event is provided. The system includes at least one vehicular component; a battery for supplying electrical power to the at least one vehicular component; a contactor for providing electrical communication between the at least one vehicular component and the battery when the contactor is in a closed configuration; a battery management unit in communication with the contactor and being adapted to provide a disconnect signal that results in the contactor achieving an open configuration that severs a power connection between the at least one vehicular component and the battery; a crash detection unit adapted to emit a crash signal upon making a determination as to whether the crash event has occurred; an airbag control unit adapted to emit an airbag deployment signal upon reception of the crash signal from the crash detection unit; the battery management unit being adapted to sense a signal that indicates that the crash event has occurred from the airbag control unit for emitting the disconnect signal; and a feedback system adapted to generate a feedback signal that indicates whether the contactor is placed in the open configuration.

In a further illustrative embodiment, a method for disconnecting electrical power in an automobile upon detecting a crash event is provided. The method includes providing a battery disposed in the automobile; connecting at least one vehicular component to the battery for supplying electrical power to the at least one vehicular component; detecting whether a crash event has occurred; emitting a crash signal from a crash detection unit to a controller area network that is in communication with a plurality of control units disposed in the automobile; sensing a signal that indicates that the crash event has occurred from the controller area network by a battery management unit; and in response to the sensing of the signal that indicates that the crash event has occurred, emitting a disconnect signal from the battery management unit to a contactor between the at least one vehicular component and the battery for severing a power connection between the at least one vehicular component and the battery.

In yet another illustrative embodiment, a method for disconnecting electrical power in an automobile upon detecting a crash event is provided. The method includes providing a battery disposed in the automobile; connecting at least one vehicular component to the battery for providing electrical power to the at least one vehicular component; detecting whether a crash event has occurred; emitting a crash signal from a crash detection unit; detecting the crash signal by an airbag control unit and, in response to the detecting of the crash signal, emitting an airbag deployment signal from the airbag control unit; sensing a signal that indicates that the crash event has occurred by a battery management unit; in response to the sensing of the signal that indicates that the crash event has occurred, emitting a disconnect signal from the battery management unit to a contactor between the at least one vehicular component and the battery for severing a power connection between the at least one vehicular component and the battery; and generating a feedback signal that indicates whether the power connection between the at least one vehicular component and the battery has been severed.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1 depicts a schematic of a controller area network of an electric vehicle;

FIG. 2 illustrates a schematic of a battery management unit, a battery and a plurality of vehicular components of an electric vehicle;

FIG. 3 shows a schematic of an electrical connection between a battery management unit, a controller area network and a crash detection unit;

FIG. 4 illustrates a schematic of an electrical connection between a battery management unit, an airbag control unit and a pretensioner control unit, and a crash detection unit;

FIG. 5 shows a schematic of an electrical connection between a battery management unit and a crash detection unit;

FIG. 6 depicts a flow chart of an embodiment of events that lead to a battery being disconnected from one or more vehicular components;

FIG. 7 illustrates flow chart of another embodiment of events that lead to a battery being disconnected from one or more vehicular components;

FIG. 8 depicts flow chart of a further embodiment of events that lead to a battery being disconnected from one or more vehicular components;

FIG. 9 illustrates flow chart of another embodiment of events that lead to a battery being disconnected from one or more vehicular components; and

FIG. 10 illustrates flow chart of yet another embodiment of events that lead to a battery being disconnected from one or more vehicular components.

### DETAILED DESCRIPTION

Systems and methods for automatic disconnection of a battery from one or more vehicular components disposed in an electric vehicle upon detection of a crash event are described.

In an embodiment of an electric vehicle, a crash event is detected by a crash detection unit which subsequently emits a crash signal to a controller area network (CAN). The CAN is in communication with a plurality of control units including a battery management unit (BMU). As a signal that indicates the occurrence of a crash travels through the CAN, the BMU senses that a crash has occurred and, in turn, emits a battery disconnect signal that causes a contactor to sever an electrical power connection between a battery and one or more vehicular components of the electric vehicle. In some embodiments, the crash signal emitted by the crash detection unit and received by the CAN is the same signal that is sensed by the BMU for triggering the disconnect signal. However, in other embodiments, the CAN receives the crash signal from the crash detection unit and emits a different or modified signal to units disposed along the CAN, such as the BMU, indicating that a crash has occurred.

In another embodiment of an electric vehicle, a crash event is detected by a crash detection unit which subsequently emits a crash signal to an airbag control unit (ACU) and a pretensioner control unit (PCU). The ACU and the PCU are also in electrical communication with a BMU. Upon reception of the crash signal from the crash detection unit, subsequently, the ACU emits an airbag deployment signal and the PCU emits a pretensioner deployment signal for respective activation of an airbag and a pretensioner. The BMU, in turn, senses a signal that indicates that a crash event has to occurred and subsequently emits a battery disconnect signal to a contactor that is disposed between a battery and one or more vehicular components of the electric vehicle. Once the contactor receives the disconnect signal, an electrical power connection between a battery and the vehicular component(s) is cut off. In some embodiments, the BMU senses the airbag deployment signal and/or the pretensioner deployment signal and subsequently emits the disconnect signal. In other embodiments, ACU and PCU each emit a signal to the BMU that indicates that a crash has occurred (and is separate from the airbag deployment signal or pretensioner deployment signal) which triggers the battery disconnect signal from the BMU.

In a further embodiment of an electric vehicle, a crash event is detected by a crash detection unit which subsequently emits a crash signal to an ACU independently of a PCU. The ACU may be in electrical communication with a BMU. In some cases, the ACU may emit a signal that triggers operation of the PCU. Upon reception of the crash signal from the crash detection unit, subsequently, the ACU emits an airbag deployment signal for a corresponding airbag to be activated. The BMU, in turn, senses a signal that indicates that a crash event has occurred and subsequently emits a battery disconnect signal to a contactor that is disposed between a battery and one or more vehicular components. Once the contactor receives the disconnect signal, an electrical power connection between a battery and the vehicular component(s) is cut off. In some embodiments, the BMU senses the airbag deployment signal and subsequently emits the disconnect signal. In other embodiments, the ACU emits a signal to the BMU that indicates that a crash has occurred (and is separate from the airbag deployment signal) which triggers the battery disconnect signal from the BMU.

Upon opening of the contactor for disconnection of the battery from the one or more vehicular components, a feedback signal may be generated so that a verification can be made that electrical power is, indeed, removed from the vehicular component(s). Or, a feedback signal may be generated to indicate whether a contactor has been placed in an open configuration. A feedback signal may be generated from any appropriate source. For example, the feedback signal can originate from the contactor, from the vehicular component(s), the CAN, and/or an independent unit for determining whether the vehicular component(s) is supplied with electrical power or not. In one embodiment, the feedback signal may be supplied via the CAN. In this respect, control units (e.g., to ACU, BMU) may sense the feedback signal and make a determination of whether to continue or cease emission of their respective signals (e.g., airbag deployment, battery disconnect). Thus, contactors and access of vehicular components to power source(s) may be tightly controlled.

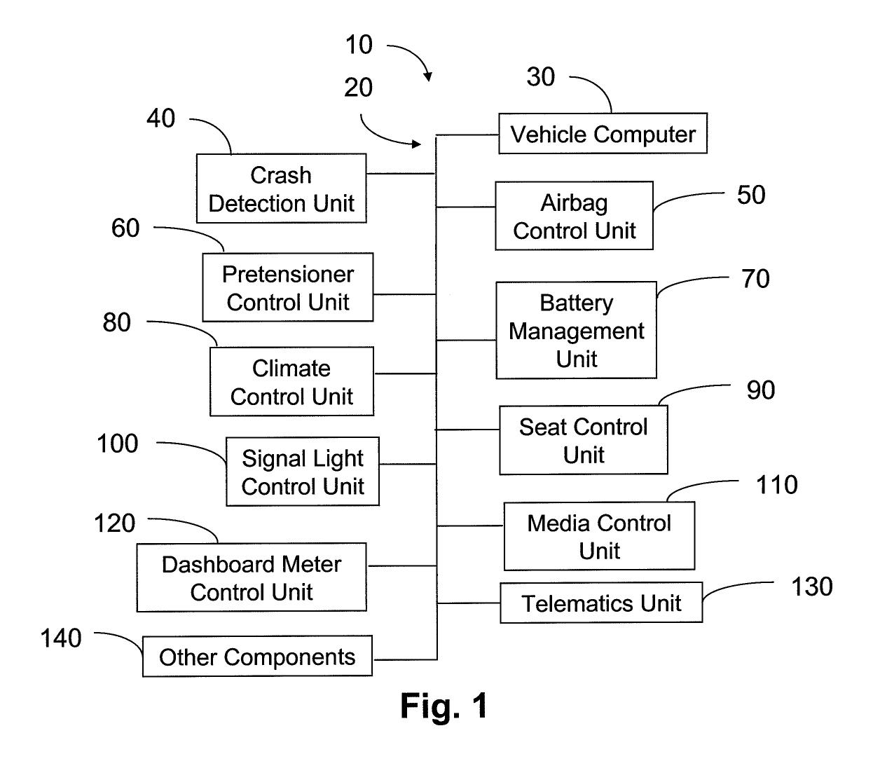

Referring to FIG. 1, a schematic embodiment of a CAN 10 in an electric vehicle is depicted. CAN 10 includes a communication bus 20 that provides an electrical interconnection network that permits information in the form of data signals to travel between different electrical components that are disposed along the CAN. In some embodiments, CAN 10 includes a serial bus communication system where data is sent sequentially over bus 20 one bit at a time. In some cases, network speeds between electrical components of over 1 Mbps are achieved along such a network.

A number of electrical components are disposed along and in communication with CAN 10. As illustrated, components disposed along and in communication with CAN 10 include a vehicle computer 30, a crash detection unit 40, an ACU 50, a PCU 60, a BMU 70, a climate control unit 80, a seat control unit 90, a signal light control unit 100, a media control unit 110, a dashboard meter control unit 120, a telematics unit 130 and other electrical components 140. It should be understood that any suitable component(s) may be in communication with CAN 10. For example, sensors, actuators and/or other devices for controlling various vehicular aspects such as antilock brakes, traction, stability systems, electronic steering, suspension, keyless entry and/or other systems may be in communication with CAN 10.

Electrical components may be conveniently connected to the CAN so as to be in electrical communication with other components disposed along the CAN. Similarly, electrical components may be conveniently disconnected from the CAN, as desired. In some embodiments, electrical components are hot-swappable along access points along the CAN. In other embodiments, appropriate vehicle maintenance techniques are used for electrical components to be added to the CAN and/or removed from the CAN. For example, contactors connected to the CAN or other components are placed in an open configuration, for safety reasons, prior to addition or removal of electrical components in the CAN.

In some instances, communication bus 20 of CAN 10 is a one wire or two wire system. In a two wire system, wires are twisted together as a pair so as to substantially eliminate electromagnetic interference. In an embodiment, communication bus 20 of to CAN 10 includes a fiber optic cable. The speed at which data travels along a bus 20 may vary depending on the protocol to which the CAN 10 adheres.

For example, in a bus 20 that supports low speed data transmission, data signals may travel less than 10 Kbps. Data signals that are transmitted at such speeds may be limited to simple functions such as control operation of power windows, power seats, power mirrors, power door looks, remote trunk, gas panel release and lights and/or other such functions.

In a bus 20 that supports intermediate speed data transmission, data signals travel at speeds from about 10 Kbps to about 125 Kbps. Signals that are transmitted at such speeds may give rise to more involved functions than low speed signals, for example, having to do with electronic transmission controls, electronic instrumentation, security systems, climate control and/or other controls.

In a bus 20 that supports faster speed data transmission, data signals travel up to 1 Mbps or more. At such signal transmission rates, high speed functions for control of more complex aspects such as powertrain control modules, airbag modules, antilock brake systems, stability control systems, onboard entertainment systems (e.g., audio/video streaming) and/or other such intricate systems may be supported.

Data signals are sent and received along CAN 10 by nodes that are in electrical communication with bus 20. Nodes may correspond to electrical components such as control units schematically depicted in FIG. 1. In some embodiments, nodes have unique network addresses on the communication bus. Nodes having unique network addresses provide electrical components with the ability to receive and process data input for certain functions while being able to ignore signals that are intended to be received by other components in communication with the CAN 10. In some cases, information that is transmitted along bus 20 is coded so that other electrical components will recognize where the information came from and what function is intended to be served.

Components, such as sensors, actuators and control devices, that have nodes disposed along the CAN 10 may be connected to a processor that interprets signals transmitted to and from the bus 20. In some embodiments, a processor receives and stores data bits serially from the bus 20 so that messages or commands are presented to the component. In other embodiments, a processor transmits messages or commands to other components disposed along the CAN 10 in the form of data bits via communication bus 20.

In an embodiment, a vehicle computer 30 functions to process various signals that may travel through bus 20 of the CAN 10. In some cases, computer 30 monitors the travel of electrical signals through bus 20. Alternatively, computer 30 may serve to regulate which electrical signals are permitted or not permitted to travel along bus 20. Although it is shown in FIG. 1 that any signal emitted by an electrical component disposed along the CAN 10 may be received by each of the other electrical components, it can be appreciated that in some embodiments, the vehicle computer 30 receives the signal and processes the information in a filtering step prior to any of the other electrical components being able to receive and process the signal.

Diagnostics may be performed on components distributed along a CAN 10. For example, a computer 30 may generate a signal or series of signals to be sent over the communication bus 20 to other electrical components. Such signals may request information to be sent back from the electrical components regarding functionality of the individual component(s). If all systems are functioning properly, then feedback signals sent back to the computer 30 from various electrical components will indicate proper functioning of their respective systems. If any systems have malfunctioned, then in some cases, a feedback signal will be sent back to the computer 30 indicating the presence of a malfunction. In other cases, upon a component malfunction, computer 30 will not receive a feedback signal, which would indicate that a problem has occurred.

A crash detection unit 40 may serve to sense whether a crash event has occurred in the electric vehicle. The crash detection unit 40 may include any appropriate sensor(s) (e.g., impact sensor(s), accelerometer(s), pressure sensor(s), speed sensor(s), gyroscope(s)) for sensing a condition of the vehicle. One or more crash detection units 40 may also be positioned at any appropriate location on the electric vehicle. In various embodiments, crash detection units 40 are disposed on frontal, side and rear locations of the vehicle.

The crash detection unit 40 may also include a processor for making a determination as to whether a crash event has occurred. In some cases, the processor of the crash detection unit 40 determines that a crash event has occurred when a particular threshold has been reached in one or more sensors included in the crash detection unit 40. For example, when an accelerometer detects a sharp deceleration of a particular degree, a processor in the crash detection unit 40 may determine that a crash event has transpired. In one embodiment, a deceleration of more than about 10 mph (e.g., about 14-15 mph) will be sufficient for a crash detection unit 40 to determine that a crash event has occurred. It can be appreciated that any appropriate condition detected by sensors in a crash detection unit may indicate the occurrence of a crash event.

In an example, a crash detection unit 40 includes a microelectromechanical system (MEMS) accelerometer. The MEMS accelerator has a microscopic mechanical element that moves in response to a rapid deceleration. A rapid deceleration of a sufficient degree will give rise to a change in capacitance on the MEMS device that is detectable on an integrated circuit located on the crash detection unit 40 so as to determine that a crash event has occurred.

Crash events of different types can be detected. For example, a crash event could be a minor crash, a major crash or a crash based on impact at a particular location of the vehicle (e.g., front, side, rear). In some embodiments, a crash detection unit includes a rollover sensor where a determination is made as to whether the vehicle has rolled over. Based on information detected from one or more sensors, a processor in a crash detection unit can make a determination as to the type of crash event that has occurred. Accordingly, the crash detection unit 40 emits a crash signal to components in the electric vehicle that provides information as to the type of crash event.

Generally, the occurrence of a crash event of a sufficient degree will trigger the initiation of appropriate safety mechanism(s) incorporated in the vehicle. For example, an appropriately located airbag system and/or a seatbelt pretensioner may be activated upon detection of a crash event. In some embodiments, once the crash detection unit 40 has determined that a crash event has occurred, the crash detection unit 40 emits a crash signal to the CAN 10 where components along the CAN may receive an indication of a crash. In other embodiments, once a crash event has occurred, the crash detection unit 40 emits a crash signal to one or more other components in the electric vehicle besides the CAN 10 (e.g., ACU, PCU and/or BMU components). For example, the crash detection unit 40 may emit a crash signal over a dedicated line to other components independently of the CAN.

Although FIG. 1 depicts crash detection unit 40 to be included as a separate component disposed along the CAN 10, it can be appreciated that elements of a crash detection unit may be incorporated into other components disposed along the CAN. For example, a crash detection unit may be incorporated into an ACU 50, a PCU 60 and/or a BMU 70 as a crash detection sensor and/or processor. Accordingly, a crash signal may to be emitted from such a crash detection unit directly to the appropriate electrical component (e.g., ACU 50, PCU 60 and/or BMU 70). Embodiments illustrated below provide examples where a crash signal is emitted directly to an ACU 50, a PCU 60 or a BMU 70 independently from a CAN.

An airbag control unit 50 may be included in the electric vehicle, In the embodiment shown in FIG. 1, ACU 50 is in communication with CAN 10. As discussed above, ACU 50 may or may not include a crash detection unit 40. Upon reaching a particular threshold detected by the crash detection unit 40, a processor in the ACU 50 that detects a signal indicative of a crash may subsequently emit an airbag deployment signal that triggers release of an appropriately located airbag, For example, such a signal that indicates that a crash has occurred may be received by the ACU 50 directly from a crash detection unit, a PCU 60 and/or from CAN 10.

Because a vehicle speed may change rapidly in a crash, crash detection and subsequent airbag inflation occurs quickly. In some embodiments, the decision to deploy the airbag is made within 15 to 30 milliseconds after impact. In one embodiment, airbag release includes the ignition of a gas generator propellant that rapidly inflates a fabric (e.g., nylon) bag in a time span of approximately 20 to 30 milliseconds. From the onset of a crash, in some embodiments, the process of detection, deployment and inflation can range between about 40 to 80 milliseconds.

In an example, one or more pyrotechnic devices are used to initiate airbag release. An electric match that includes an electrical conductor wrapped in a combustible material is heated by an electric current to ignite the combustible material and, hence, also ignite the gas propellant. Subsequently, a rapid chemical reaction that generates an inert gas (e.g., nitrogen, argon) in the airbag ensues. In an embodiment, an airbag deployment signal that is emitted by ACU 50 causes an electric current to be produced so as to heat and ignite the combustible material.

Further, the airbag may include small vent holes that permit gas to escape in a controlled manner as a vehicle occupant collides with the bag. The characteristics of each airbag (e.g., volume, vent size) may vary according to the type of vehicle and its safety arrangement.

As discussed above, signals detected by ACU 50 that indicate a crash event may originate from one or more sensors, a crash detection unit 40, a PCU 60 and/or CAN 10. Upon determination that an airbag should be deployed, for electric vehicles with multiple airbags (e.g., front, side, rear, passenger airbags), a processor in the ACU 50 may determine which of the airbags are to be activated. Such a determination may depend on various factors, for example, the severity/force of the crash, the angle of impact and/or where on the vehicle the crash has occurred. Accordingly, appropriate airbag deployment signal(s) may be emitted from the ACU 50 based on the above determination. In addition, other safety mechanisms may also be triggered, such as one or more seatbeit pretensioners and/or battery disconnection from one or more vehicular components, as will be described further below.

In addition to an ACU 50, some embodiments of an electric vehicle include a pretensioner control unit 60. In an embodiment, similar to ACU 50, PCU 60 is in communication with a crash detection unit 40. In some cases, PCU 60 already has a crash detection sensor incorporated within it. In other cases, a crash detection unit is separate from PCU 60. Upon reaching a particular threshold detected by the crash detection unit 40, a processor in the PCU 60 that detects a signal that indicates the occurrence of a crash event may subsequently emit a pretensioner deployment signal. A pretensioner deployment signal, in turn, activates an appropriate seatbelt pretensioner which functions to tighten a seatbelt. In some embodiments, a signal that indicates that a crash has occurred may be received by the PCU 60 directly from a crash detection unit, an ACU 50 and/or from CAN 10.

Conventional locking mechanisms typically include a retractor device that restrains the seatbelt from extending further, However, instead of merely preventing extension, a pretensioner serves to pull in on the belt. Thus, when a vehicle crash occurs, a passenger is brought to a more secure crash position in his/her seat as a pretensioner tightens the seatbelt by taking up extra slack that may be present. It can be appreciated that pretensioners may be used in combination with conventional locking mechanisms rather than in place of them

Any appropriate type of pretensioner may be used. In an embodiment, the pretensioner involves a pyrotechnic device that includes a small chamber that contains ignitable material disposed adjacent to a larger chamber that contains a combustible gas. The smaller chamber includes one or more electrodes wired to the PCU 60 that are used to ignite the combustible gas. A piston resides within the larger chamber and is further connected to a rack gear that is engaged to a pinion. The pinion, in turn, is connected to a spool mechanism that is configured to wind and/or release portions of the seatbelt strap.

Upon a processor in the PCU 60 making a determination for the pretensioner to be activated, the PCU 60 generates the pretensioner deployment signal which triggers an electric current to be applied across the electrode(s). Such a current gives rise to a spark that ignites the combustible gas in the larger chamber. The ignition generates a significant amount of outward pressure which forcefully drives the piston, and hence, the rack gear in an upward motion. As the rack gear travels upward, the pinion causes the spool mechanism to rotate in an angular direction so as to retract any slack that may be present in the seatbelt it can be appreciated that once a pretensioner that includes a pyrotechnic device is activated, the pyrotechnic portion must be replaced after use.

A battery management unit 70 may also be disposed along CAN 10, as illustrated in the schematic shown in FIG. 1. Although crash detection unit 40 is illustrated as being separate from BMU 70, in some embodiments, BMU 70 incorporates a crash detection unit. When a particular threshold is reached by the crash detection unit, a processor in the BMU 70 that detects a signal indicative of a crash may then generate a battery disconnect signal that severs a power connection between a battery and one or more vehicular components. For example, such a signal that indicates that a crash has occurred may be received by the BMU 70 directly from a crash detection unit, an ACU 50, a PCU 60 and/or from CAN 10.

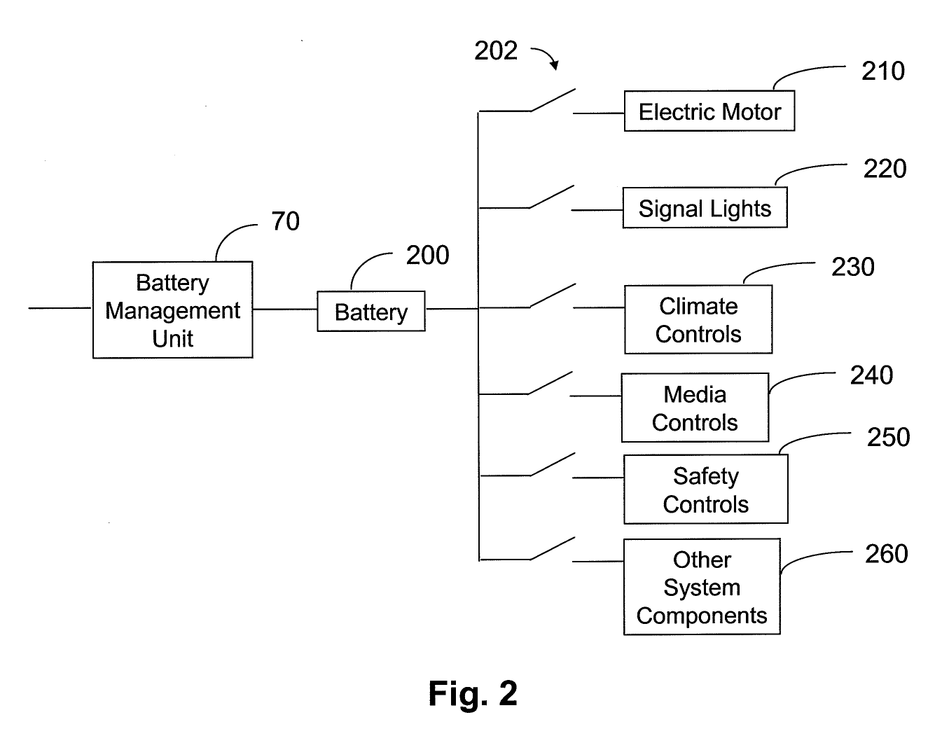

As depicted by FIG. 2, BMU 70 is in electrical communication with a battery 200 and a plurality of contactors 202. Contactors 202 provide electrical connection between the battery 200 and various vehicular components. For example, battery 200 is in electrical communication, via separate contactors 202, with an electric motor 210, signal lights 220, climate controls 230, media controls 240, safety controls 250, and/or other system components 260. It can be appreciated that a significant number of vehicular components that are not explicitly shown or described herein may be in communication with battery 200 through a corresponding contactor 202.

When contactor 202 is in a closed configuration with respect to battery 200 and a vehicular component, electrical current is permitted to flow between the battery 200 and the component so as to provide power to the component. Conversely, when contactor 202 is in an open configuration with respect to battery 200 and a vehicular component, power is not provided to the component because electrical current is unable to flow between the component and battery 200. As discussed, BMU 70 controls whether a contactor 202 between battery 200 and a particular vehicular component is in an open or closed configuration. For example, power is severed between battery 200 and a particular vehicular component when BMU 70 emits a disconnect signal that is appropriate for and received by the corresponding contactor.

In some embodiments, BMU 70 controls contactors 202 such that certain vehicular components are provided with power from battery 200 and other vehicular components are not. In other embodiments, BMU 70 controls contactors for more than one battery. Accordingly, a vehicular component may be in electrical communication with a number of batteries (not shown) through respective contactors that are, in turn, controlled by BMU 70.

When a crash event has occurred, a processor in BMU 70 makes a determination as to whether power is to be cut off from certain vehicular components (e.g., those that require significant power during operation). Accordingly, BMU 70 may emit a battery disconnect signal that causes one or more contactors 202 to be placed in an open configuration, severing a power connection between the battery 200 and one or more vehicular components that correspond to the contactors.

As discussed above, for some embodiments, a processor of crash detection unit 40 makes a determination as to whether a crash event has occurred and emits a crash signal. Accordingly, a processor in BMU 70 makes a further determination as to whether one or more contactors 202 should be placed in an open configuration. It can be appreciated that the severity of the crash may be communicated between a crash detection unit 40 and BMU 70. In one embodiment, based on a signal originated by crash detection unit 40, BMU 70 detects that a minor crash has occurred. Thus, in response, BMU 70 may emit a disconnect signal that places a relatively small number of contactors in an open configuration. For example, in the event of a minor crash, BMU 70 may effectively sever battery power to electric motor 210 and climate controls 230 while leaving the other system components with battery power. In another embodiment, BMU 70 detects that a major crash has occurred, and thus, a large number of contactors are placed in an open configuration. When a large number of contactors are placed in an open configuration, battery power to a greater number of vehicular components is severed as compared to that in a minor crash. For example, when a major crash has transpired, a processor in BMU 70 may make a decision to emit a disconnect signal that cuts off battery power to all electrical system components in the vehicle.

A telematics unit 130 may also be disposed along CAN 10. As discussed above, when the BMU 70 emits a disconnect signal for a contactor 202 to disconnect an electrical connection between a battery 200 and a vehicular component, a feedback signal may be generated that indicates whether power has actually been severed. Telematics unit 130 may receive information as to the overall status of the vehicle, such as what type of crash event has occurred, if any, whether any safety mechanisms have been deployed (e.g., airbag), and/or whether electrical power has been disconnected from any vehicular component(s). Telematics unit 130 relays the vehicle status information to a separate location where appropriate personnel are able to receive the vehicle status information. For example, telematics personnel may receive status information that the battery has been disconnected from the electric motor from telematics unit 130, and such personnel will be able to communicate that information to emergency personnel that are in close proximity to the vehicle.

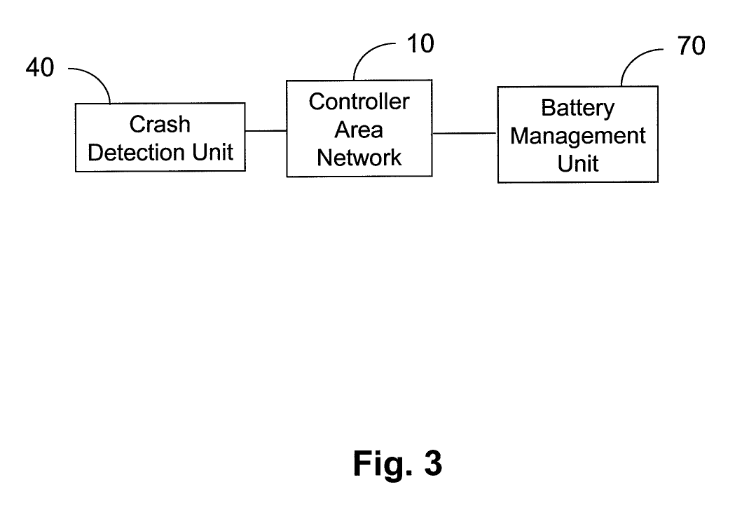

FIGS. 3-5 depict schematic embodiments that illustrate the electrical connection between crash detection unit 40 and BMU 70. In some embodiments, various components are electrically disposed between crash detection unit 40 and BMU 70. In other embodiments, no components are electrically disposed between crash detection unit 40 and BMU 70. In further embodiments, BMU 70 contains a crash detection unit in the form of one or more sensors and/or a crash detection processor.

In the embodiment depicted by FIG. 3, a CAN 10 is electrically disposed between crash detection unit 40 and BMU 70. Thus, a crash signal emitted by crash detection unit 40 is transmitted to CAN 10 before BMU 70 detects that a crash event has transpired. BMU 70 senses a signal from CAN 10 that signifies that a crash event has occurred and a processor in BMU 70 then makes a determination as to which contactors should be placed in an open configuration, if any, Accordingly, an appropriate battery disconnect signal is generated by BMU 70 and received by the appropriate contactors,

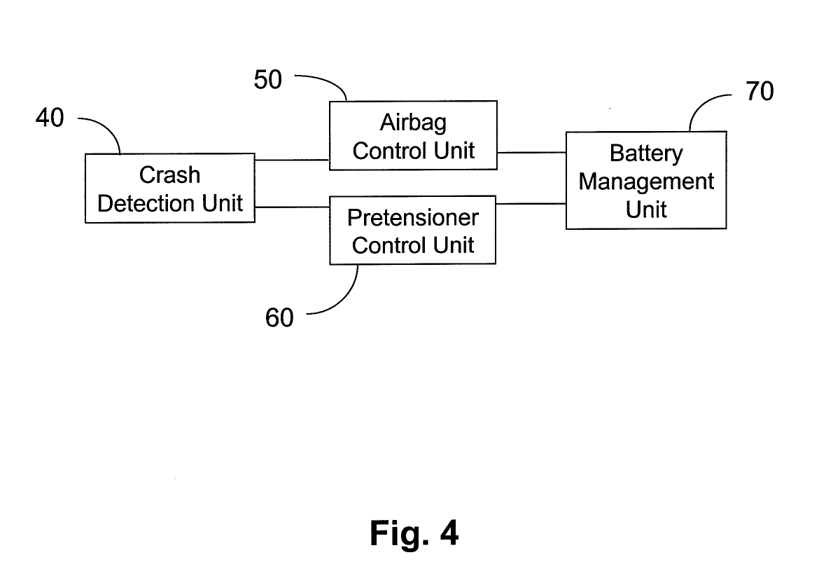

In FIG. 4, ACU 50 and PCU 60 are disposed directly between crash detection unit 40 and BMU 70 as a dedicated connection independent of a CAN 10. Accordingly, a crash signal that originates from crash detection unit 40 is transmitted to ACU 50 and PCU 60 prior to detection of a crash even by BMU 70, In this embodiment, BMU 70 senses that a crash event has occurred via signals emitted from ACU 50 and PCU 60 and then determines which contactors are to be placed in an open configuration, if any, In some embodiments, ACU 50 and PCU 60 detect a crash signal from crash detection unit 40 and processors in ACU 50 and PCU 60, respectively, make determinations as to whether corresponding airbag and/or pretensioner mechanisms are to be deployed. To trigger such safety mechanisms, respective airbag deployment and/or pretensioner deployment signals are emitted. These signals may be detected by BMU 70 which may then control opening of appropriate contactors, accordingly. In some embodiments, BMU 70 detects a signal indicative of a crash event that is separate from the airbag or pretensioner deployment signals. Indeed, ACU 50 and/or PCU 60 may emit a separate signal that is received by BMU 70 that indicates to BMU 70 that a crash event has taken place.

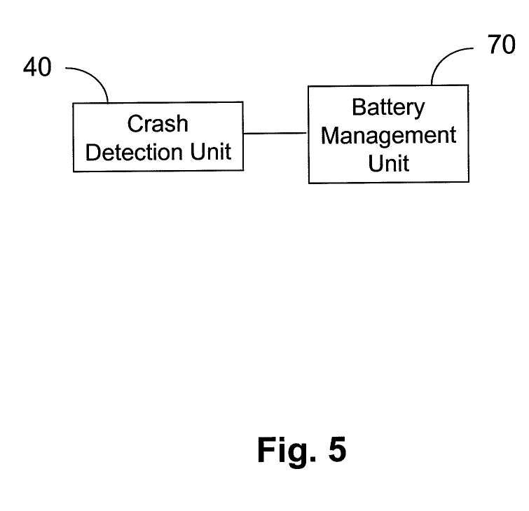

FIG. 5 illustrates an embodiment where crash detection unit 40 is directly connected to BMU 70 as another dedicated line independent of a CAN. In this embodiment, a crash signal emitted by crash detection unit 40 is received by BMU 70 and, based on the degree of the crash, a disconnect signal is emitted that leads to appropriate contactors being placed into an open configuration.

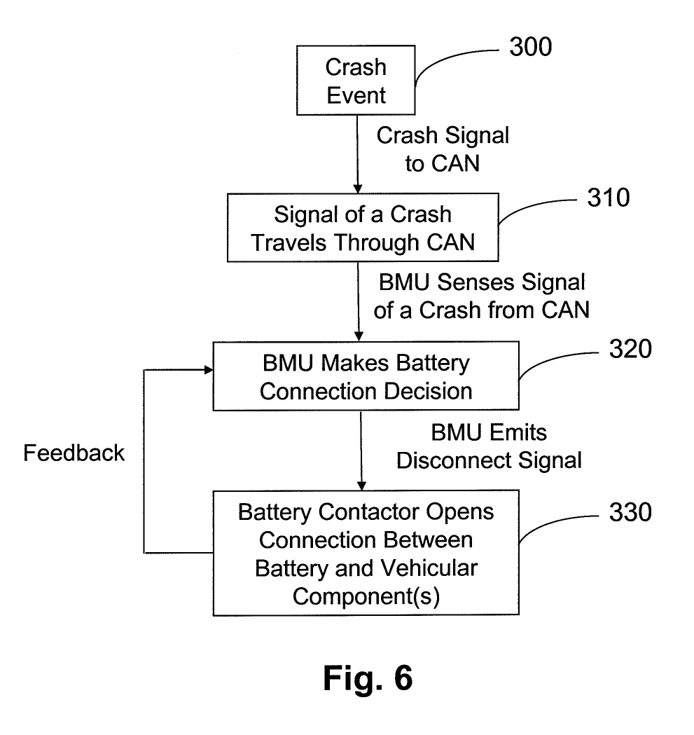

The following FIGS. 6-9 present various flowchart embodiments that follow a chain of events from the moment of a crash occurrence. As indicated above, a BMU may detect one or more signals that indicate the occurrence of a crash event from any appropriate component in the vehicle. Such components may include, but are not limited to, a crash detection unit that is separate from the BMU, a CAN, an ACU, a PCU or a combination thereof.

FIG. 6 illustrates a flowchart where a crash event 300 has occurred. Once the crash event has been detected (e.g., by a crash detection unit), a crash signal is emitted to the vehicle CAN. A signal that indicates that a crash has occurred then travels through the CAN 310. A BMU, which is electrically connected to the CAN senses the signal that indicates occurrence of the crash from the CAN. A processor in the BMU subsequently makes a decision 320 as to whether battery power will be cut off from one or more vehicular components. Once the decision 320 has been made, the BMU emits a battery disconnect signal so that the appropriate contactors between the battery and the selected vehicular component(s) are then placed in an open configuration 330. A feedback mechanism may be employed where a signal is generated for indicating whether contactors have been opened resulting in power connection cut off to the vehicular component(s).

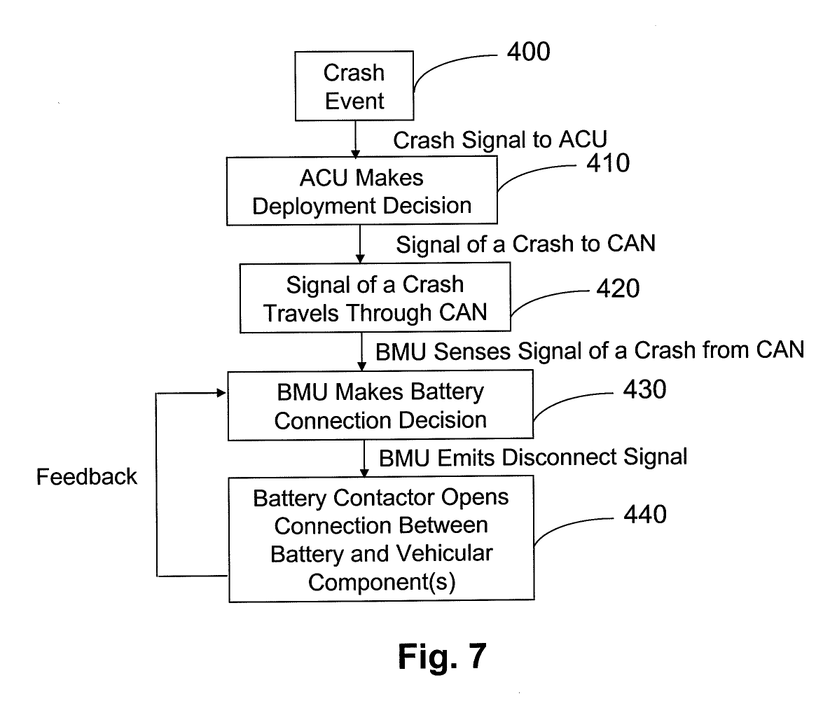

In another flowchart embodiment illustrated by FIG. 7, a crash event 400 transpires. Upon detection of the crash event, a crash signal is sent to the ACU. In some embodiments, a crash signal is sent to the ACU via a CAN. In other embodiments, a crash signal is sent directly to the ACU independent from a CAN. A processor in the ACU subsequently makes a decision 410 about whether to deploy an airbag. For example, such a decision can be based upon the degree of the crash event. If the airbag is deployed, the ACU then emits an appropriate signal to the CAN where a signal that indicates the occurrence of the crash event then travels through the CAN 420. In some cases, ACU emits an intermittent signal to the CAN. For example, a signal emission from the ACU may occur every 100 milliseconds for 3 seconds. A BMU electrically connected to the CAN then senses a signal (originating from either the ACU or and CAN) that indicates the occurrence of the crash. Subsequently, a processor in the BMU makes a decision 430 as to whether battery power will be disconnected from one or more vehicular components. Upon making the decision of whether to disconnect battery power, the BMU generates a battery disconnect signal so that the appropriate contactors between the battery and vehicular component(s) are placed in an open configuration 440. A feedback mechanism may also be utilized where a signal is generated to indicate whether contactors have been opened in cutting off power connection to the vehicular component(s).

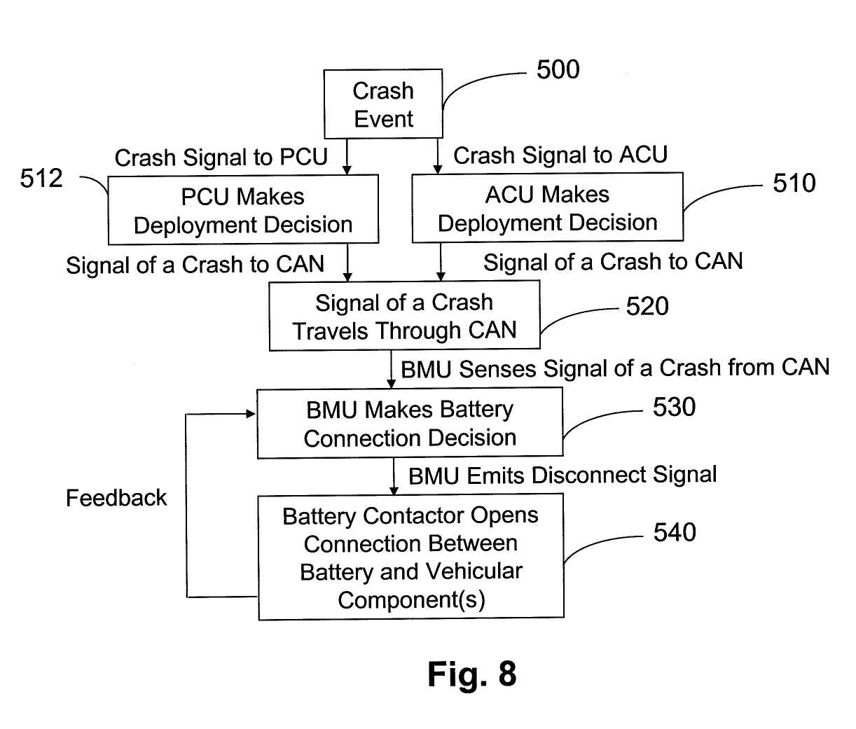

FIG. 8 depicts a different flowchart embodiment when a crash event 500 occurs. When the crash event is detected, a crash signal is sent to both the ACU and the PCU. In some embodiments, a crash signal is sent to the ACU and PCU via a CAN. In other embodiments, a crash signal is sent directly to the ACU and PCU independent from a CAN. In further embodiments, a crash signal is sent first to the ACU and then subsequently to the PCU, or vice versa. As described above, a processor in the ACU makes a decision 510 about whether to deploy an airbag. Similarly, a processor in the PCU also makes a decision 512 as to whether to activate a pretensioner. If the airbag and the pretensioner are to be deployed, the ACU and the PCU send out respective deployment signals to the corresponding airbag and pretensioner devices for appropriate activation. The airbag and pretensioner deployment signals may also be emitted to the CAN which results in a signal that indicates the occurrence of the crash event traveling through the CAN 520. Alternatively, the ACU and/or PCU may emit a separate signal to the CAN that also can result in a signal that indicates that a crash event has occurred traveling through the CAN 520. The BMU senses the signal from the CAN and then a to processor in the BMU makes a decision 530 as to whether disconnection of battery power from one or more vehicular components is to occur. Accordingly, an appropriate battery disconnect signal is generated and respective contactors between the battery and vehicular component(s) are placed in an open configuration 540, based on decision 530. A feedback mechanism is employed where a signal is emitted that indicates whether contactors have been opened cutting off power connection to the vehicular component(s).

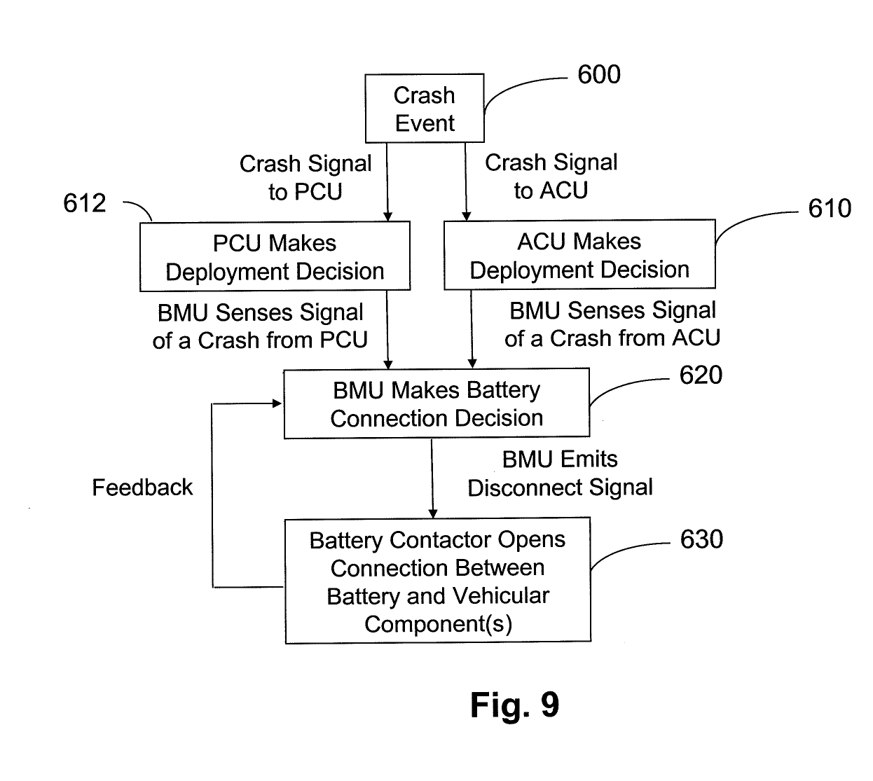

In a further flowchart embodiment depicted in FIG. 9, a crash event 600 occurs. Upon detection of the crash event, a crash signal is sent to the ACU and/or the PCU. In some embodiments, a crash signal is sent first to the ACU and then subsequently to the PCU, or vice versa, or only to either the ACU or the PCU. A processor in the ACU makes a decision 610 regarding deployment of an airbag. A processor in the PCU also makes a decision 612 regarding activation of a pretensioner. If the airbag and the pretensioner are to be deployed, the ACU and the PCU send out respective deployment signals to the corresponding airbag and pretensioner devices for appropriate deployment. Upon deployment of the airbag and/or the pretensioner, the airbag and/or pretensioner deployment signals may also be emitted from the ACU and/or PCU to the BMU. In some cases, the ACU and/or PCU may generate separate signals directly to the BMU that indicates to the BMU that a crash event has occurred. The BMU senses the signal(s) from the ACU and/or the PCU and a processor in the BMU makes a decision 620 as to whether battery power is to be disconnected from the one or more vehicular components. Then, from decision 620, the BMU emits a battery disconnect signal to the appropriate contactors so that battery power is severed to corresponding vehicular component(s) 630. A feedback mechanism may be employed where a signal is generated that indicates whether contactors have been opened for cut off of electrical power to the vehicular component(s). FIG. 9 depicts a system where contactors are opened as a result of a crash event independently from a CAN.

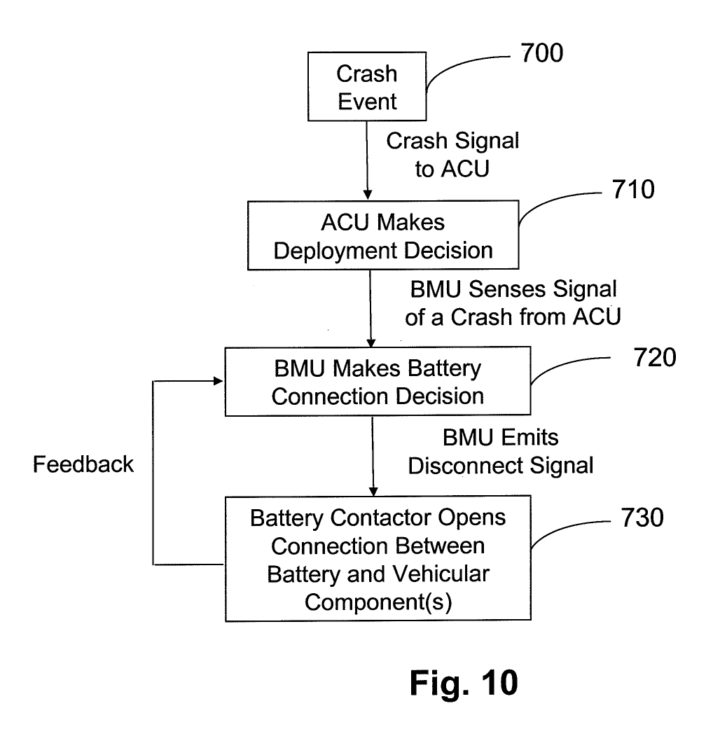

In another flowchart embodiment depicted in FIG. 10 that is independent from a CAN, a crash event 700 occurs. Upon detection of the crash event, a crash signal is sent to the ACU. A processor in the ACU makes a decision 710 regarding deployment of an appropriate airbag. If the airbag is to be deployed, the ACU sends out a deployment signal to the corresponding airbag for deployment. Upon deployment of the airbag, the airbag deployment signal may also be emitted from the ACU to the BMU. The BMU senses the signal from the ACU and a processor in the BMU makes a decision 720 as to whether battery power is to be disconnected from the one or more vehicular components. From decision 720, the BMU emits a battery disconnect signal to the appropriate contactors so that battery power is severed to corresponding vehicular component(s) 730. A feedback mechanism as described above may also be employed.

U.S. Provisional Patent Application No. 61/334,406, filed May 13, 2010, and entitled “Battery Disconnection in Electric Vehicles” is incorporated herein by reference in its entirety for all purposes.

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1. A system in an automobile adapted to disconnect electrical power in the automobile upon detection of a crash event, the system comprising:
at least one vehicular component;
a battery for supplying electrical power to the at least one vehicular component;
a contactor for providing electrical communication between the at least one vehicular component and the battery when the contactor is in a closed configuration;
a battery management unit in communication with the contactor and being adapted to provide a disconnect signal that results in the contactor achieving an open configuration that severs a power connection between the at least one vehicular component and the battery;
a crash detection unit adapted to emit a crash signal upon making a determination as to whether the crash event has occurred; and
a controller area network in communication with a plurality of control units including the battery management unit and the crash detection unit, wherein upon occurrence of the crash event, the controller area network is adapted to receive the crash signal from the crash detection unit and the battery management unit is adapted to sense a signal that indicates that the crash event has occurred from the controller area network for emitting the disconnect signal.

2. The system of claim 1, further comprising an airbag control unit adapted to emit an airbag deployment signal upon reception of the crash signal from the crash detection unit.

3. The system of claim 1, further comprising a pretensioner control unit adapted to emit a pretensioner deployment signal upon reception of the crash signal from the crash detection unit.

4. The system of claim 1, further comprising a feedback system adapted to generate a feedback signal that indicates whether the contactor is placed in the open configuration.

5. A system in an automobile adapted to disconnect electrical power in the automobile upon detection of a crash event, the system comprising:
at least one vehicular component;
a battery for supplying electrical power to the at least one vehicular component;
a contactor for providing electrical communication between the at least one vehicular component and the battery when the contactor is in a closed configuration;
a battery management unit in communication with the contactor and being adapted to provide a disconnect signal that results in the contactor achieving an open configuration that severs a power connection between the at least one vehicular component and the battery;
a crash detection unit adapted to emit a crash signal upon making a determination to as to whether the crash event has occurred;
an airbag control unit adapted to emit an airbag deployment signal upon reception of the crash signal from the crash detection unit;
the battery management unit being adapted to sense a signal that indicates that the crash event has occurred from the airbag control unit for emitting the disconnect signal; and
a feedback system adapted to generate a feedback signal that indicates whether the contactor is placed in the open configuration.

6. The system of claim 5, further comprising a controller area network in communication with a plurality of control units including the battery management unit and the crash detection unit, wherein upon occurrence of the crash event, the controller area network is adapted to receive the crash signal from the crash detection unit and the battery management unit is adapted to sense the signal that indicates that the crash event has occurred from the controller area network for emitting the disconnect signal.

7. The system of claim 5, further comprising a pretensioner control unit adapted to emit a pretensioner deployment signal upon reception of the crash signal from the crash detection unit.

8. A method for disconnecting electrical power in an automobile upon detecting a crash event, the method comprising:
providing a battery disposed in the automobile;
connecting at least one vehicular component to the battery for supplying electrical power to the at least one vehicular component;
detecting whether a crash event has occurred;
emitting a crash signal from a crash detection unit to a controller area network that is in communication with a plurality of control units disposed in the automobile;
sensing a signal that indicates that the crash event has occurred from the controller area network by a battery management unit; and
in response to the sensing of the signal that indicates that the crash event has occurred, emitting a disconnect signal from the battery management unit to a contactor to between the at least one vehicular component and the battery for severing a power connection between the at least one vehicular component and the battery.

9. The method of claim 8, further comprising detecting the crash signal by an airbag control unit and, in response to the detecting of the crash signal, emitting an airbag deployment signal from the airbag control unit resulting in deployment of an airbag.

10. The method of claim 8, further comprising detecting the crash signal by a pretensioner control unit and, in response to the detecting of the crash signal, emitting a pretensioner deployment signal from the pretensioner control unit resulting in deployment of a pretensioner system.

11. The method of claim 8, further comprising generating a feedback signal that indicates whether the power connection between the at least one vehicular component and the battery has been severed.

12. A method for disconnecting electrical power in an automobile upon detecting a crash event, the method comprising:
providing a battery disposed in the automobile;
connecting at least one vehicular component to the battery for providing electrical power to the at least one vehicular component;
detecting whether a crash event has occurred;
emitting a crash signal from a crash detection unit;
detecting the crash signal by an airbag control unit and, in response to the detecting of the crash signal, emitting an airbag deployment signal from the airbag control unit;
sensing a signal that indicates that the crash event has occurred by a battery management unit;
in response to the sensing of the signal that indicates that the crash event has occurred, emitting a disconnect signal from the battery management unit to a contactor between the at least one vehicular component and the battery for severing a power connection between the at least one vehicular component and the battery; and
generating a feedback signal that indicates whether the power connection between the at least one vehicular component and the battery has been severed.

13. The method of claim 12, further comprising sensing the signal that indicates that the crash event has occurred from the controller area network by a battery management unit and, in response to the sensing of the signal that indicates that the crash event has occurred, emitting a disconnect signal from the battery management unit to the contactor for severing a power connection between the at least one vehicular component and the battery.

14. The method of claim 12, further comprising detecting the crash signal by a pretensioner control unit and, in response to the detecting of the crash signal, emitting a pretensioner deployment signal from the pretensioner control unit resulting in deployment of a pretensioner system.
